(19) United States
(12) Patent Application Publication
(10) Pub. No.: US 2005/0070138 A1
(43) Pub. Date: Mar. 31, 2005

(54) Slim USB Plug and Flash-Memory Card with Supporting Underside Ribs Engaging Socket Springs

(75) Inventors: Ren-Kang Chiou, Fremont, CA (US); Jim Chin-Nan Ni, San Jose, CA (US)

Correspondence Address: STUART T AUVINEN, 429 26TH AVENUE, SANTA CRUZ, CA, 95062-5319, US

(73) Assignee: Super Talent Electronics Inc., San Jose, CA (US)

(21) Appl. No.: 10/904,529

(22) Filed: Nov. 15, 2004

Related U.S. Application Data
(63) Continuation-in-part of application No. 10/605,146, filed on Sep. 11, 2003, now Pat. No. 6,854,984.
(63) Continuation-in-part of application No. 10/904,207, filed on Oct. 28, 2004.

(51) Int. Cl. H01R 12/00

(52) U.S. Cl. 439/76.1

(57) ABSTRACT

A two-piece flash-memory-drive card has an integrated slim Universal-Serial-Bus (USB) connector that fits into a standard USB socket. The slim USB connector has 4 metal contacts on a board that is encapsulated by a lower plastic case but no upper plastic case. Components are mounted onto the board on the side opposite the metal contacts and are covered by the lower plastic case. A thinner portion of the plastic case forms a light window that allows a light-emitting diode on the board to shine through the case. The lower plastic case is bonded to the board with adhesive or using snaps. Supporting underside ribs in the lower plastic case opposite the metal contacts allow most of the card to be thinner than the space inside the standard USB socket.

### RELATED APPLICATIONS

This application is a continuation-in-part of the co-pending application for “Slim USB Connector with Spring-Engaging Depressions, Stabilizing Dividers and Wider End Rails for Flash-Memory Drive”, U.S. Ser. No. 10/605,146, filed Sep. 19, 2003, now U.S. Pat. No. ______ and “Manufacturing Methods for Ultra-Slim USB Flash Memory Card with Supporting Dividers or Underside Ribs”, U.S. Ser. No. 10/904,207, filed Oct. 28, 2004.

### FIELD OF THE INVENTION

This invention relates to reduced-height Universal-Serial-Bus (USB) connectors, and more particularly to flash-memory-drive cards using reduced-height connectors.

### BACKGROUND OF THE INVENTION

Flash-memory technologies such as those using electrically-erasable programmable read-only memory (EEPROM) have produced chips storing 1 G-Bytes or more. Small flash-memory cards have been designed that have a connector that can plug into a specialized reader, such as for compact-flash, secure-digital, memory stick, or other standardized formats.

More recently, flash memory cards are being sold that contain a USB connector. Such USB-flash memory cards do not require a specialized reader but can be plugged into a USB connector on a personal computer (PC) or other hosting device. These USB-flash memory cards can be used in place of floppy disks and are known as USB key drives, USB thumb drives, and a variety of other names. These USB-flash cards can have a capacity of more than ten floppy disks in an area not much larger than a large postage stamp.

FIG. 1A shows a prior-art flash-memory card with a USB connector. Flash memory chip 12 may be a 128 Mega-byte non-volatile chip or may have some other capacity. Controller chip 14 contains a flash-memory controller that generates signals to access memory locations within flash memory chip 12. Controller chip 14 also contains a USB interface controller that serially transfers data to and from flash memory chip 12 over a USB connection.

USB connector 20 may be mounted on board 10, which is a small circuit board with chips 12, 14 mounted thereon. Multi-layer printed-circuit board (PCB) technology can be used for board 10. A plastic case (not shown) can surround board 10.

USB connector 20 contains a small connector substrate 16, which is often white ceramic, black rigid plastic, or another sturdy substrate. Connector substrate 16 has four or more metal contacts 18 formed thereon. Metal contacts 18 carry the USB signals generated or received by controller chip 14. USB signals include power, ground, and serial differential data D+, D.

USB connector 20 contains a metal case that wraps around connector substrate 16. The metal case touches connector substrate 16 on three of the sides of connector substrate 16. The top side of connector substrate 16, holding metal contacts 18, has a large gap to the top of the metal case. On the top and bottom of this metal wrap are formed holes 15. USB connector 20 is a male connector, such as a type-A USB connector.

FIG. 1B shows a female USB connector. Female USB connector 22 can be an integral part of a PC, or can be connected by cable 21. Another connector substrate 26 contains four metal contacts 28 that make electrical contact with the four metal contacts 18 of the male USB connector 20 of FIG. 1A. Connector substrate 26 is wrapped by a metal case, but small gaps are between the metal case and connector substrate 26 on the lower three sides.

Locking is provided by metal springs 24 in the top and bottom of the metal case. When male USB connector 20 of FIG. 1A is flipped over and inserted into Female USB connector 22 of FIG. 1B, metal springs 24 lock into holes 15 of male USB connector 20.

FIGS. 2A, 2B are cross-sections highlighting connections between male and female USB connectors. Female USB connector 22 is on the left while male USB connector 20 is being inserted from the right. Male USB connector 20 is flipped over relative to the view of FIG. 1A. Metal contacts 18 are formed on the lower surface of connector substrate 16 on male USB connector 20, while metal contacts 28 are formed on the upper surface of connector substrate 26 on Female USB connector 22. Thus the metal contacts face one another to allow for electrical contact when male USB connector 20 is inserted into Female USB connector 22 as shown in FIG. 2B.

Metal springs 24 formed on the metal case surrounding connector substrate 26 on Female USB connector 22 fit into holes on the metal case of male USB connector 20. This helps to lock the connectors together.

FIG. 3 shows a prior-art USB flash memory card using a slim USB connector. Male USB connector 20 of FIGS. 1, 2 is relatively large. The metal case in particular is cumbersome and increases manufacturing cost. Costs may be reduced by integrating male USB connector 30 with board 32. Board 32 is a PCB that has flash memory chip 12 and controller chip 14 mounted thereon. Board 32 is extended to include male USB connector 30, which has metal contacts 38 formed on end 36 of board 32.

The width and thickness of board 32 at end 36 containing male USB connector 30 is designed to approximately match that of connector substrate 16 of FIG. 1A. Plastic case 34 can enclose board 32 but have an opening for metal contacts 38. Plastic case 34 can cover the bottom and sides of male USB connector 30 up to end 36 to emulate potions of the metal case of the male USB connector of FIG. 1A.

FIGS. 4A, 4B show cross-sections of the prior-art slim USB connector being inserted into a standard Female USB connector. Board 32 that has male USB connector 30 formed on end 36 is flipped over from the view shown in FIG. 3, and end 36 is inserted into female USB connector 22 from the right side.

Metal contacts 38 are located on the lower surface of male USB connector 30. Plastic case 34 has an opening on the lower surface of male USB connector 30 to expose the metal contacts so they can make electrical connection with metal contacts 28 on the upper surface of connector substrate 26 of Female USB connector 22 when inserted as shown in FIG. 4B.

Plastic case 34 helps to fill the gate between board 32 and the top edge of the metal case of Female USB connector 22. Plastic case 34 is also formed along the thin edges of board 32 and helps to fill in the gaps between connector substrate 26 and the sides of the metal case of Female USB connector 22 that are above and below the plane of FIG. 4B.

While slim USB connector 30 can be less expensive and smaller than the standard USB connector, it fits less securely into a standard Female USB connector. The lack of the metal case removes the mechanical support provided as the male metal case that fit in the gap below connector substrate 26 and the bottom side of the metal case for the female connector. The result is a noticeable wobble in the up and down direction when a USB flash memory card containing male USB connector 30 is inserted into Female USB connector 22. Vertical movement of 3-4 millimeter at the end of a 4-centimeter flash card can occur with slight finger pressure. This vertical play gives the user the feeling that the flash memory card is cheap and unreliable, even when sufficient electrical contact is made.

Parent patent Uses Dividers and End Rails to Aid Support

The parent patent, U.S. Ser. No. 10/605,146, now U.S. Pat. No. ______ disclosed using dividers between the metal USB pads and end rails to increase support for a slim USB connector. A flash-memory card using such as supporting slim USB connector was also disclosed in the parent patent.

While useful, various improvements in the slim USB connector and a flash-memory card with the slim USB connector have been developed by the inventors.

### BRIEF DESCRIPTION OF THE DRAWINGS

FIG. 1A shows a prior-art flash-memory card with a USB connector.

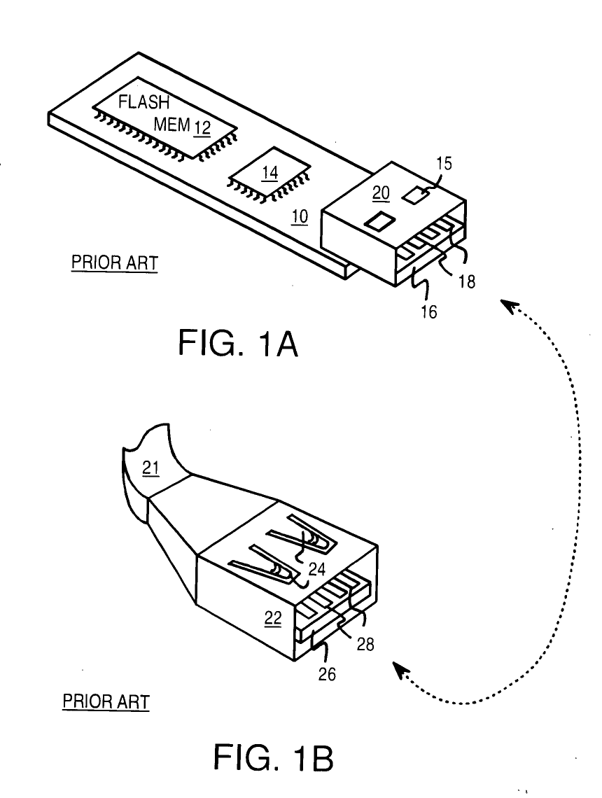

FIGS. 2A, 2B are cross-sections highlighting connections between male and female USB connectors.

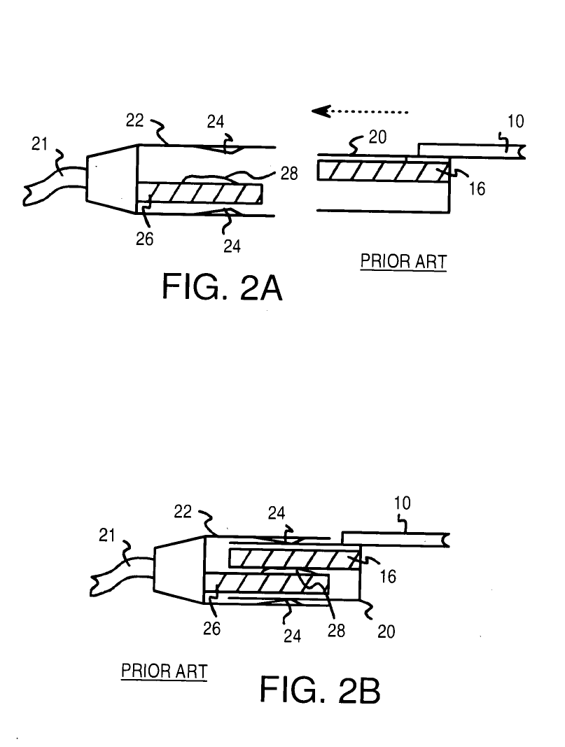

FIG. 3 shows a prior-art USB flash memory card using a slim USB connector.

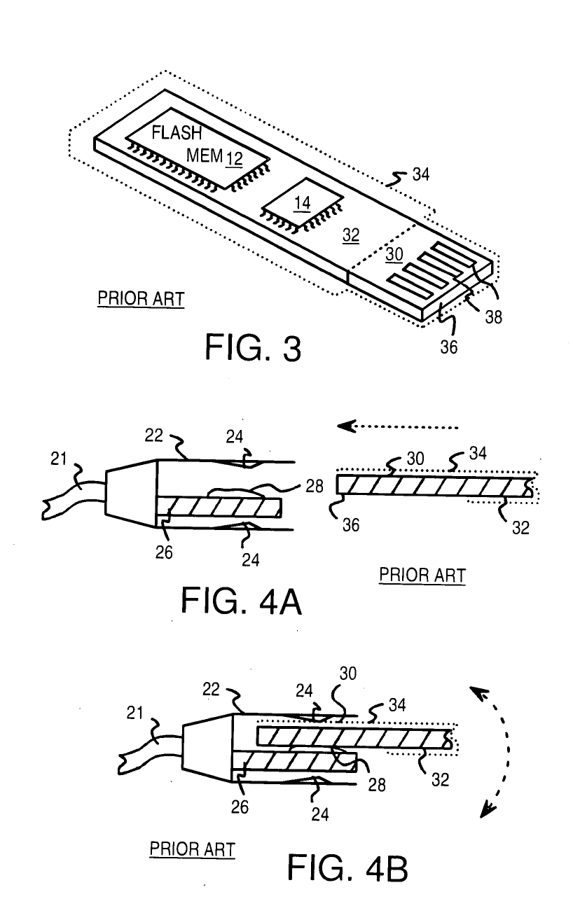

FIGS. 4A, 4B show cross-sections of the prior-art slim USB connector being inserted into a standard Female USB connector.

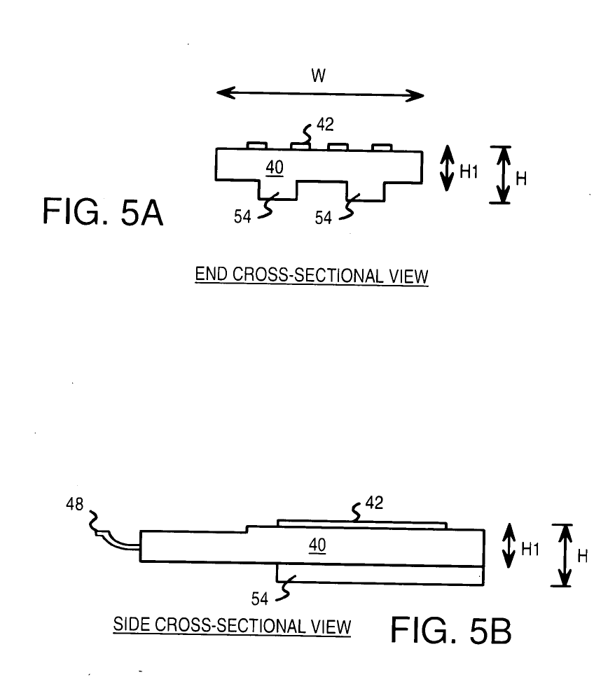

FIGS. 5A-D show a slim USB connector with a supporting underside ribs.

FIGS. 6A-B are perspective views of the male slim USB connector of FIGS. 5A-D.

FIG. 7 shows a bottom view of assembly of a male slim USB connector that is integrated with a circuit-board substrate of a flash memory card.

FIG. 8 shows a top view of assembly of a male slim USB connector that is integrated with a circuit-board substrate of a flash memory card.

FIGS. 9A-B show an integrated male slim USB connector with supporting underside ribs being inserted into a standard female USB connector.

### DETAILED DESCRIPTION

The present invention relates to an improvement in flash-memory cards with slim USB connectors. The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

The inventors have discovered that supporting ribs or bumps can be formed on the bottom side of the USB connector. These supporting ribs can slide over the metal springs, allowing the rest of the connector and the plastic case of a flash-memory card to have a reduced thickness while still providing support for a flash-memory card inserted into a standard USB socket.

These bottom-side supporting ribs can provide sufficient support so that the dividers and end rails on the top side are not needed in some embodiments. Also, locking depressions to engage the metal springs in the USB socket are not needed, since the supporting underside ribs can slide over the socket's metal springs.

A flash-memory card can be constructed from two primary pieces —a printed-circuit board (PCB) containing the USB metal contacts, and a plastic case that covers components on one side of the board. The inventors have discovered that the IC chips and other components may be mounted on the side of the board that is opposite to the 4 USB metal pads.

Rather than have a top plastic cover and a bottom plastic cover that surround the board, only a bottom plastic cover is used. The top of the board is left uncovered and forms the top of the flash-memory card. This can allow for a thinner flash-memory drive card. The top side of the board with the 4 USB pads is relatively flat when no IC chips are mounted on this side, allowing for a flatter USB drive package. Having IC chips on the same side would require that the USB drive package have a top-side plastic cover that would protrude upward to cover the IC chips.

The IC chips mounted to the bottom of the board are covered by the bottom plastic cover. The supporting underside ribs are formed on this bottom plastic cover. Since there is not top plastic cover, only the flat surface of the board on top, the thickness of the flash-memory card can be reduced in some cases from 2.7 millimeters (mm) to 1.8 mm.

A portion of the plastic case may have a reduced thickness. A light-emitting diode (LED) or light pipe may be placed near this reduced-thickness area of the plastic case, allowing the user to see an indicator light mounted to the circuit board. The indicator light can turn on or blink when the memory is being accessed or written, and various patterns or sequences could be used to indicate the different operations (constant on for reading, rapid blinks for writing, long blinks for errors, etc.)

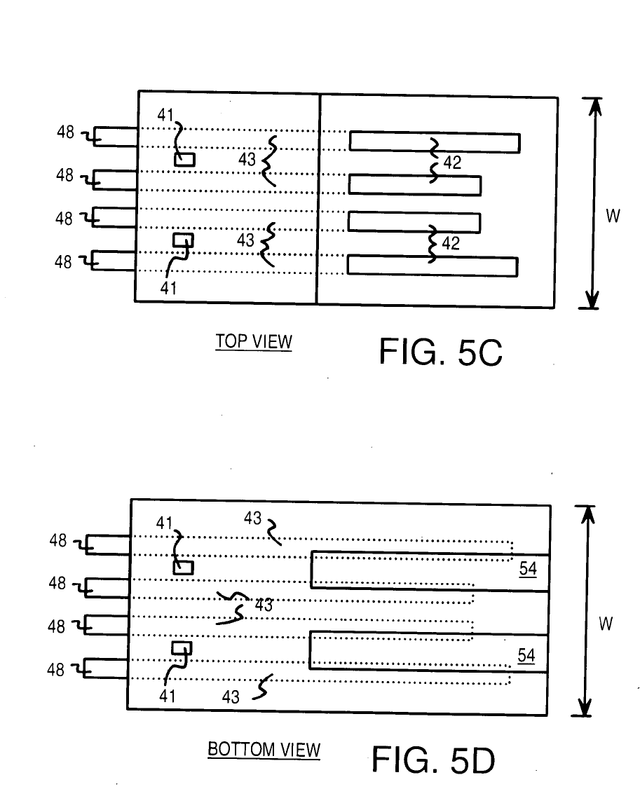

FIGS. 5A-D show a slim USB connector with a supporting underside ribs. The top or upper side may be considered to be the side having the 4 USB metal pads facing upward, while the bottom side is the side without the USB metal pads. FIG. 5A is a cross-sectional view from the plug (insertable) end of the connector, while FIG. 5B is a side cross-sectional view. FIG. 5C is a top view and FIG. 5D is a bottom (underside) view.

In FIG. 5A, the height H of male slim USB connector 40 needs to approximately match the space inside the female USB socket for a secure fit when inserted. The space is about 2.2 mm in height. Supporting underside ribs 54 allow male slim USB connector 40 to reach this height H even though other areas of male slim USB connector 40 are thinner, having a height H1. H1 can be the thickness of most areas of male slim USB connector 40, since supporting underside ribs 54 increase thickness where needed to fit the socket opening.

In one embodiment, supporting underside ribs 54 are 0.4 mm thick, allowing H1 to be 1.8 mm thick. Thus areas away from supporting underside ribs 54 in the side view of FIG. 5B and in the bottom view of FIG. 5D are only 1.8 mm thick (H1), while areas covered by supporting underside ribs 54 are thicker, at 2.2 mm thick (H). Some areas of male slim USB connector 40 may be even thinner as shown in FIG. 5B, or may be thicker (not shown).

Male slim USB connector 40 does not include a metal case surrounding a connector substrate, allowing the height H (FIGS. 5A-B) and cost of the connector to be reduced. Instead, the width W (FIG. 5A, C, D) is wider than the standard male USB connector. The width W is increased by twice the width of the metal case that wraps the standard male USB connector. Thus the increased width accounts for the missing metal case of the slim USB connector.

Visible in the cross-sections of FIGS. 5A, B and the top view of FIG. 5C, metal contacts 42 are placed on a top surface of male slim USB connector 40. Metal contacts 42 can be flat, or can have a bend in them to produce a spring action to provide better contact with the metal contacts on a female USB connector.

Tabs 48 are electrically connected to metal contacts 42 through metal lines or extensions 43 within male slim USB connector 40. Tabs 48 can be surface mounted or soldered to a circuit board such as one that contains flash memory and controller chips. Corners and shapes can be changed on some embodiments to allow for easier automated handling but may be deleted or of a different shape or size in other embodiments. Other features such as posts, notches, etc. may be present for a variety of purposes or reasons. For example, two small metal or plastic pins 41 may be provided at the rear of male slim USB connector 40 near tabs 48 to fit in holes on a board, such as a PCB. Pins 41 are for securing male slim USB connector 40 to a board, such as a PCB.

Visible in the cross-sectional views of FIGS. 5A, B and the bottom view of FIG. 5D, supporting underside ribs 54 are formed on the bottom side of male slim USB connector 40. Supporting underside ribs 54 may be aligned with the metal springs on the female USB connector. When male slim USB connector 40 is inserted into a standard female USB connector, the metal springs slide over supporting underside ribs 54, providing support for male slim USB connector 40 when inserted into a USB socket, improving alignment and mechanical stability.

The height H of male slim USB connector 40, including supporting underside ribs 54, is still less than the height of a standard male USB connector since there is no metal case wrap. The width W of male slim USB connector 40 is greater than the width of a standard male USB connector. The width is increased by twice the thickness of the metal case wrap of a standard male USB connector in one embodiment, but different widths may be used.

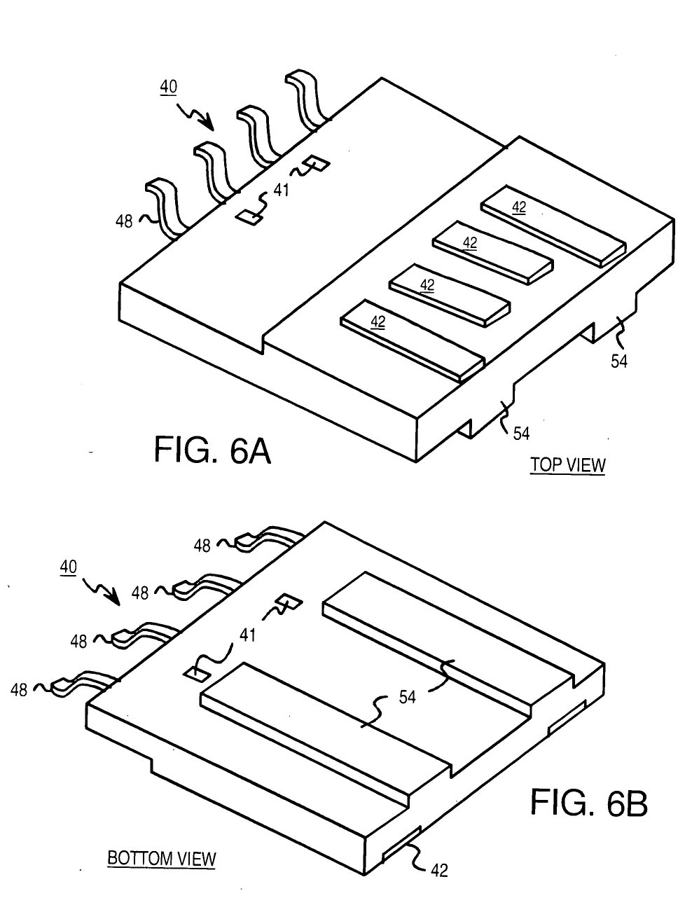

FIGS. 6A-B are perspective views of the male slim USB connector of FIGS. 5A-D. FIG. 6A shows a top view, where metal contacts 42 are visible, while FIG. 6B shows a bottom view where metal contacts 42 are hidden from view but supporting underside ribs 54 are visible. The two middle metal contacts 42 are shorter than the outer two metal contacts 42, allowing power and ground on the outer metal contacts 42 to be connected before data signals on the inner two metal contacts 42. Supporting underside ribs 54 allow the bottom surface of male slim USB connector 40 to be closer to the top surface, producing a thinner male slim USB connector 40 in all areas except at supporting underside ribs 54.

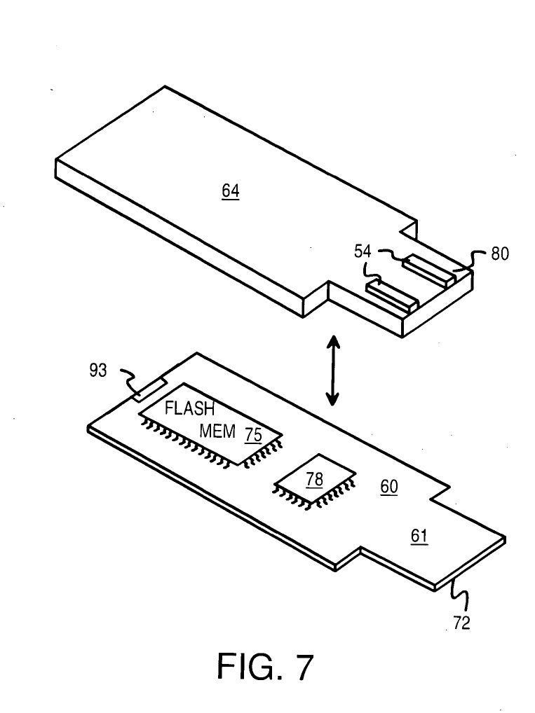

FIG. 7 shows a bottom view of assembly of a male slim USB connector that is integrated with a circuit-board substrate of a flash memory card. The USB flash-memory card is assembled from PCB board 60 and its components, and lower case 64, which are sandwiched together to form the flash-memory card. The bottom surface of board 60 is visible in FIG. 7.

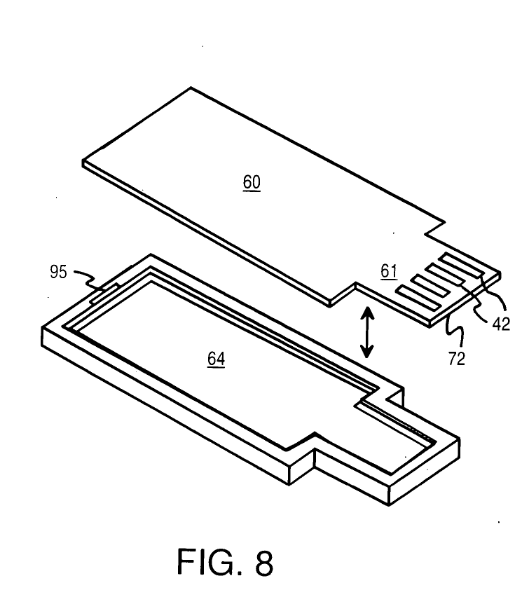

Flash memory chip 75 and controller chip 78 are mounted on the reverse (bottom) side of board 60, which can be a multi-layer PCB or similar substrate with wiring traces. FIG. 8 shows that the 4 USB contacts, metal contacts 42, are formed on the top side of board 60. Since most components are mounted on the bottom side of board 60 opposite the top side with metal contacts 42, board 60 does not need a plastic cover over its top side. This allows the flash-memory card to have a lower profile or even a co-planar top surface.

Extension 61 of board 60 has a width that approximately matches the width of the connector substrate and the metal wrap in a male USB connector. Metal contacts 42 (not visible) are formed on the top side of extension 61 to act as the USB metal contacts of the male slim USB connector. End 72 of board 60 is inserted into the female USB connector.

Lower case 64 also includes extended region 80. Supporting underside ribs 54 are formed in extended region 80. Supporting underside ribs 54 allow lower case 64 to have a smaller thickness since supporting underside ribs 54 provide additional thickness to meet the metal springs in the USB socket. A single molding can form lower case 64 with supporting underside ribs 54 in extended region 80.

LED 93 can be mounted on board 60, such as on the bottom side with other components, or extending from an edge of board 60.

FIG. 8 shows a top view of assembly of a male slim USB connector that is integrated with a circuit-board substrate of a flash memory card. The USB flash-memory card is assembled from PCB board 60 and its components, and lower case 64, which are sandwiched together to form the flash-memory card. The top surface of board 60 is visible in FIG. 8.

FIG. 8 shows that the 4 USB contacts, metal contacts 42, are formed on the top side of board 60. Since most components (not visible in FIG. 8) are mounted on the bottom side of board 60, board 60 does not need a plastic cover over its top side. This allows the flash-memory card to have a lower profile or even a co-planar top surface.

Extension 61 of board 60 has a width that approximately matches the width of the connector substrate and the metal wrap in a male USB connector. Metal contacts 42 are formed on the top side of extension 61 to act as the USB metal contacts of the male slim USB connector. End 72 of board 60 is inserted into the female USB connector.

Lower case 64 can have grooves in its sidewalls to accept board 60 during assembly. Board 60 can be attached to lower case 64 by adhesive or by snap fasteners, such as plastic snap pins or tabs in lower case-64 that fit through and lock into holes in board 60. Adhesive could be a thermal-bond or another type.

Plastic snap tabs may be semi-flexible plastic extensions or protrusion tabs formed on the edges of lower case 64 and extend upward. Holes are formed on the peripheral edges of board 60 and match positions of the plastic snap tabs in lower case 64. The peripheral outline of board 60 is somewhat smaller than for lower case 64 so that board 60 can fit inside lower case 64. During assembly, when board 60 is placed inside lower case 64, the edge of board 60 is forced into grooves in the side walls of lower case 64, which can be covered with adhesive or can have snap tabs that snap through holes in board 60 when board 60 is fully inserted into lower case 64. This locks board 60 into lower case 64. A variety of shapes can be used for plastic snap tabs and grooves.

A region of reduced thickness is formed in lower case 64 to create light window 95. Light window 95 could be formed on the back wall of lower case 64 as shown, or could be formed on the larger bottom surface of lower case 64 or on some other area of lower case 64. Light from LED 93 on board 60 (FIG. 7) can partially pass through the thinner plastic of light window 95, allowing the user to see a visible indicator of activity. A light guide or pipe could also be used to channel the light path to light window 95.

Rather than use snap tabs, adhesive can be used. Pressure or heat sensitive adhesive films can be attached to board 60 or to lower case 64 where bonding is desired. For example, an adhesive could be brushed on as a liquid or paste, or it could be a double-coated adhesive film such as 3M's 7953 film. A thermal bond film (TBF) such as 3M's TBF-0.668 could also be used.

Once board 60 and lower case 64 are pressed together with board 60 in between, the adhesive can be cured by heating the assembly, by pressing the case and board together, or by allowing sufficient time for curing.

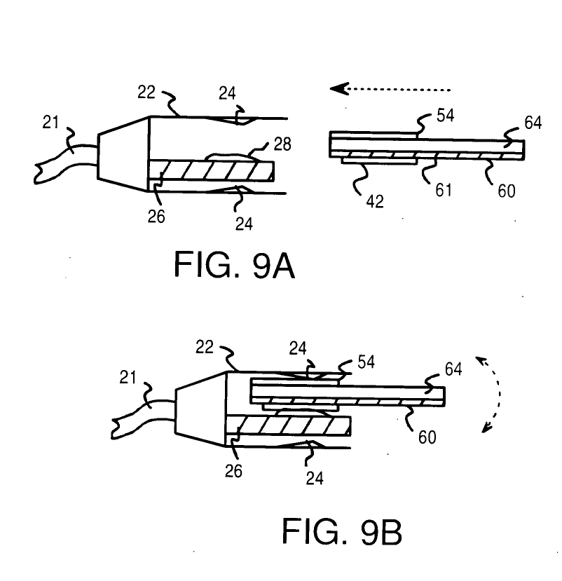

FIGS. 9A-B show an integrated male slim USB connector with supporting underside ribs being inserted into a standard female USB connector. A male slim USB connector formed on extension 61 of board 60 is inserted from the right. Since this connector is inverted for insertion, board 60 is on the bottom, and has metal contacts 42 formed near extension 61. Metal contacts 42 are formed on the lower surface of board 60 and make electrical contact with metal contacts 28 when inserted.

Metal springs 24 in female USB connector 22 slide over supporting underside ribs 54 in lower case 64. When fully inserted, as shown in FIG. 9B, metal springs 24 push against supporting underside ribs 54 to add stability and support to the thinner lower case 64. Metal springs 24 on the bottom of female USB connector 22 are not engaged since the male slim USB connector does not extend below connector substrate 26.

Supporting underside ribs 54 fill in the gap between lower case 64 and metal springs 24. This provides a better, more secure fit, reducing wobble. Vertical play or wobble is significantly reduced.

Alternate Embodiments

Several other embodiments are contemplated by the inventors. Board 60 could also be mounted over the tops of side walls of lower case 64. In that variation the edges of board 60 are exposed rather than covered by lower case 64. In some embodiments board 60 could be the same area or ever larger than lower case 64, or vice-versa.

Snap-tabs with movable latching teeth or extensions or locking portions may also be used. Different thicknesses and dimensions can be substituted for the examples given.

Rather than mount packaged IC's onto the bottom-side of board 60, unpackaged die may be mounted using die-bonding techniques. Using unpackaged die rather than packaged die may reduce the size and weight of the card.

The supporting underside ribs or bumps can be merged together into a larger rectangle or take on other shapes while still providing support. Three or more ribs could be used. When the supporting ribs are not used, the locking depressions of the parent patent could be used or could be omitted. The supporting ribs could be eliminated altogether by increasing the thickness of the lower plastic case, to meet the 2.2 mm supported height. A two-piece design could still be used, with the PCB forming the top cover and the thicker bottom cover being thick enough to meet the height of the gap in the USB socket.

A variety of materials may be used for the connector substrate, circuit boards, metal contacts, metal case, etc. Plastic cases can have a variety of shapes and may partially or fully cover different parts of the circuit board and connector, and can form part of the connector itself. Various features can have a variety of shapes and sizes. Oval, round, square, rectangular, trapezoidal, and other shapes may be used.

The slim connector may be considered “half-height”, since it fits on one side of the female's connector substrate but not on the other side of the female's connector substrate. The actual “half-height” connector may not be exactly half the height of a standard connector, but is considered “half-height” because it engages only half of the female connector. The slim connector may be a reduction in height of only 30-40% rather than exactly half.

The slim connector may be widened to accommodate extra metal contacts to become an extended-USB connector for future USB specification. Moreover, the width of the slim connector can be widened, and the height and metal contacts of the slim connector can be varied, making it into a general-purpose slim connector, for USB, extended-USB, PCI Express, mini PCI Express applications, etc.

Other embodiments may use a stand-alone male slim USB connector rather than the integrated male slim USB connector.

Other applications besides flash drives include USB connectors on desktop computers, notebook computers, PDA's, digital cameras, cellular phones or handsets, TV set-top boxes, MP3, MPEG4, copiers, printers, and other electronic devices. Such devices may use to advantage the slim-ness of the new male and/or female USB connectors, and may reduce size and space together with lower cost. A USB flash drive with the new slim male connector can still be directly inserted into a host PC with a legacy female USB connector.

There are 4 pins in the current USB pin out definition—VCC, GND, D+, and D−. VCC is the 5V power pin. GND is the ground pin and D+ and D-are the differential data I/O pins. For the USB 2.0 specification, data transfer rates are up to 480M bits/sec, and the power supply current is 500 mA. These might not meet future (or even some current) needs of speed and power associated with some USB devices, such as large flash memory cards.

Additional metal contacts can be added to the new connectors. These additional metal contacts can serve as power, ground, and/or I/O pins which are extensions to the USB specification, or as PCI Express (or mini PCI Express) specifications. Greater power capability can be obtained with (or without) additional power and ground pins (or by a higher power supply current of the existing power pin). Multiple power supplies can also be provided by the additional power and ground pins. The improved power supply capabilities allow more devices and/or more memory chips to be powered. Extra I/O pins can be added for higher bandwidth and data transfer speeds. The additional I/O pins can be used for multiple-bit data I/O communications, such as 2, 4, 8, 12, 16, 32, 64, . . . bits. By adopting some or all of these new features, performance of flash memory cards/devices can be significantly improved. These additional pins could be located behind or adjacent to the existing USB pins, or in various other arrangements. The additional pins could be applied to male and female connectors, both the current or the new slim connectors. New types of flash memory cards/devices can be made with these new connectors, which have the additional pins.

Any advantages and benefits described may not apply to all embodiments of the invention. When the word “means” is recited in a claim element, Applicant intends for the claim element to fall under 35 USC Sect. 112, paragraph 6. Often a label of one or more words precedes the word “means”. The word or words preceding the word “means” is a label intended to ease referencing of claims elements and is not intended to convey a structural limitation. Such means-plus-function claims are intended to cover not only the structures described herein for performing the function and their structural equivalents, but also equivalent structures. For example, although a nail and a screw have different structures, they are equivalent structures since they both perform the function of fastening. Claims that do not use the word “means” are not intended to fall under 35 USC Sect. 12, paragraph 6. Signals are typically electronic signals, but may be optical signals such as can be carried over a fiber optic line.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. An ultra-slim Universal-Serial-Bus (USB) connector comprising:
a connector substrate;
a plurality of metal contacts disposed on a contact surface of the connector substrate, the metal contacts for carrying USB signals; and
supporting underside ribs formed below the connector substrate on a second surface opposite to the contact surface;
wherein the supporting underside ribs are for sliding over but not engaging metal socket springs from a female USB connector when the ultra-slim USB connector is inserted into the female USB connector.

2. The ultra-slim USB connector of claim 1 wherein a width of the ultra-slim USB connector is wider than a substrate within a standard male USB connector, but a supported height of the ultra-slim USB connector through the supporting underside ribs is less than a height of a metal case surrounding a standard male USB connector.

3. The ultra-slim USB connector of claim 2 wherein an unsupported height of the ultra-slim USB connector for a cross-section that is not through the supporting underside ribs is less than the supported height by at least 0.2 millimeter (mm).

4. The ultra-slim USB connector of claim 3 wherein the supported height is about 2.2 mm and the unsupported height is 1.8 mm or less.

5. The ultra-slim USB connector of claim 2 further comprising:
a circuit substrate containing wiring traces;
wherein the connector substrate is attached to the circuit substrate or is an extension portion of the circuit substrate.

6. The ultra-slim USB connector of claim 5 further comprising:
a flash memory chip mounted on the circuit substrate.

7. The ultra-slim USB connector of claim 6 further comprising:
a controller chip mounted on the circuit substrate, for reading data from and for writing data to the flash memory chip and sending the data over the metal contacts as USB signals to the female USB connector.

8. The ultra-slim USB connector of claim 7 further comprising:
a plastic case that partially surrounds the circuit substrate and covers the flash memory chip and the controller chip;
wherein the supporting underside ribs are for filling in a gap between the second surface of the connector substrate and a metal wrap in the female USB connector when the ultra-slim USB connector is inserted into the female USB connector,
wherein the supporting underside ribs are formed from a lower portion of the plastic case that covers the second surface of the connector substrate.

9. A two-piece card with an integrated slim Universal-Serial-Bus (USB) connector comprising:
a connector substrate;
a plurality of metal contacts disposed on a first surface of the connector substrate, the metal contacts for carrying USB signals and for making physical contact with metal pads on a female USB socket when the two-piece card is inserted;
one or more integrated circuits mounted to a second surface of the connector substrate, the second surface being a side of the connector substrate that is opposite the first surface; and
a lower case for encapsulating the second surface of the connector substrate when assembled, wherein the first surface of the connector substrate is exposed.

10. The two-piece card of claim 9 further comprising:
supporting underside ribs formed on the lower case in an insertion end underneath the connector substrate, the insertion end for inserting into the female USB socket, the supporting underside ribs increasing a thickness of the insertion end of the two-piece card relative to a thickness of the two-piece card away from the supporting underside ribs,
whereby card thickness is reduced away from the supporting underside ribs.

11. The two-piece card of claim 10 wherein a thickness of the insertion end of the two-piece card, including a thickness of the supporting underside ribs, is about 2.2 millimeters, wherein a non-insertion end of the two-piece card that does not include the thickness of the supporting underside ribs is about 1.8 millimeters or less.

12. The two-piece card of claim 10 wherein the lower case is a plastic case;
wherein the connector substrate is bonded to the lower case during assembly by inserting snap tabs in the lower case into holes in the connector substrate, or by an adhesive.

13. The two-piece card of claim 10 further comprising:
a light window formed by a thinning of plastic in the lower case, the light window allowing some light from a light-emitting diode to pass through the lower case; and
a light-emitting diode mounted to the connector substrate, for generating light for passing through the light window to indicate a status to a user.

14. The two-piece card of claim 10 wherein the supporting underside ribs slide over metal socket springs on the female USB socket.

15. The two-piece card of claim 10 wherein the connector substrate is a printed-circuit board (PCB) containing wiring traces.

16. The two-piece card of claim 15 wherein the one or more integrated circuits mounted to the second surface of the connector substrate comprises:
a flash memory chip.

17. The two-piece card of claim 16 wherein the one or more integrated circuits mounted to the second surface of the connector substrate further comprises:
a controller chip mounted on the connector substrate, for reading data from and for writing data to the flash memory chip and sending the data over the metal contacts as USB signals to the female USB socket.

18. A Universal-Serial-Bus (USB) card assembly comprising:
a circuit board having wiring traces, the circuit board having four metal contacts on an insertion end of a contact side of the circuit board, the four metal contacts for connecting to USB contacts in a USB socket when inserted;
a lower case for substantially covering a reverse side opposite the contact side of the circuit board when assembled;
wherein at least a majority of the contact side of the circuit board is not covered by the lower case when assembled;
chips mounted to the reverse side of the circuit board, the chips including a memory chip;
wherein the circuit board is bonded to the lower case with the chips encased between the circuit board and the lower case when assembled; and
supporting underside ribs formed on an insertion end of the lower case, the supporting underside ribs situated in a direction parallel to the four metal contacts when assembled.

19. The USB card assembly of claim 18 further comprising:
wherein a height of the insertion end of the USB card assembly is less than a standard height of a standard USB male connector,
whereby the USB card assembly has a reduced height.

20. The USB card assembly of claim 19 further comprising:
wherein the supporting underside ribs are located to engage metal springs on the USB socket,
whereby the supporting underside ribs provide a secure fit into the USB socket when inserted.

21. The USB card assembly of claim 19 further comprising:
an adhesive applied to the circuit board or applied to the lower case before assembly,
whereby the adhesive bonds the circuit board to the lower case during assembly.

22. The USB card assembly of claim 19 wherein the lower case comprises:
a bottom;
perimeter sidewalls around a perimeter of the bottom; and
grooves in the perimeter sidewalls of the lower case, the grooves having a shape and size to fit edges of the circuit board during assembly.

23. A reduced-height Universal-Serial-Bus (USB) plug card comprising:
circuit board means for supporting integrated circuits on a bottom side, having an insertion end for insertion into a USB socket;
metal contactor means, formed on the insertion end of a top side of the circuit board means, for making electrical contact with a USB socket when the insertion end is inserted into the USB socket;
bottom body means, formed from plastic, for encapsulating the integrated circuits on the bottom side of the circuit board means; and
bottom support means, formed on the insertion end of the bottom body means, for sliding along metal springs on the USB socket during insertion;
whereby stability when inserted into the USB socket is increased by the bottom support means.

24. The reduced-height USB plug card of claim 23 further comprising:
light window means, formed by a thinning of plastic in the bottom body means, for allowing some light from a light-emitting diode to pass through; and
a light-emitting diode mounted to the circuit board means, for generating light for passing through the light window means to indicate a status to a user.
